(19) United States
(12) Patent Application Publication
(10) Pub. No.: US 2016/0123368 A1
(43) Pub. Date: May 5, 2016

(54) FASTENER FOR BLIND HOLE

(71) Applicant: Ira Svendsgaard and Associates, Placerville, CA (US)

(72) Inventor: Peter Svendsgaard, Placerville, CA (US)

(21) Appl. No.: 14/532,460

(22) Filed: Nov. 4, 2014

(51) Int. Cl. F16B 31/00; F16B 39/22

(52) U.S. Cl. CPC F16B 31/00; F16B 39/22

(57) ABSTRACT

Provided is a tension control bolt assembly for securing two or more substrates together through a blind hole. The assembly includes a bolt having a central shaft attached to a proximal head. The bolt includes one or more engagement surfaces on a proximal portion configured to be engaged by an associated application tool. The proximal portion is mechanically separable from the central shaft. The tension control bolt assembly also includes a first washer which defines structure to enable the bolt and the first washer to be inserted into a vertically oriented substrate hole. The tension control bolt assembly includes a second washer and a nut. One example includes a bolt having one or two complete revolutions of threads exposed after proper tightening of the nut. Another example includes a serrated surface configured to limit rotational motion during a fastening operation.

### BACKGROUND

1. Field of the Disclosure

This application relates generally to high-strength bolts, and more specifically to high-strength bolts including features enabling use with blind holes oriented in one or more planes, and which, when applied, visually demonstrate the clamping force generated by the bolt.

2. Description of Related Art

Currently available high-strength blind fasteners for construction and structural applications are generally provided with a bolt head with a diameter suitable to pass through the blind hole and a means of preventing the bolt head from passing through the blind hole. These configurations typically require some form of sleeve which expands within the hole or expands to form a washer on the exterior of the hole. Other configurations require a structures and methods which cannot be easily applied in multiple planes and other orientations. Additionally, many of such fasteners do not provide visual demonstration of the clamping force generated by the fastener. Finally, many such fasteners do not permit the generation of a clamping force adequate for structural applications. Accordingly, improvements to high-strength blind fasteners, and in particular, bolts are desired.

### SUMMARY

The following presents a simplified summary in order to provide a basic understanding of some example aspects of the disclosure. This summary is not an extensive overview. Moreover, this summary is not intended to identify critical elements of the disclosure nor delineate the scope of the disclosure. The sole purpose of the summary is to present some concepts in simplified form as a prelude to the more detailed description which is presented later.

According to one aspect, the subject application involves a tension control bolt assembly for securing two or more substrates together through a substrate hole. Only one side of the substrate hole is functionally accessible by an operator. The tension control bolt assembly includes a bolt. The bolt includes a distal portion and a proximal head located at the distal portion. The proximal head includes an outside diameter which is lesser than a diameter of the substrate hole. The bolt further includes a central shaft attached to the proximal head. The central shaft includes a central shaft diameter and a threaded portion. The bolt further includes a proximal portion attached to the central shaft. The proximal portion includes one or more engagement surfaces configured to be engaged by an associated application tool. The proximal portion is mechanically separable from the central shaft. The tension control bolt assembly also includes a first washer having a major diameter and a minor diameter. The major diameter is larger than the diameter of the substrate hole, and the first washer is configured to be passed through the substrate hole. The minor diameter is greater than the central shaft diameter and is configured to be located about a portion of the central shaft. The first washer defines structure which interacts with the associated tool to enable the bolt and the first washer to be inserted into the substrate hole having an axis oriented in any plane including the vertical. The tension control bolt assembly further includes a second washer having an exterior diameter larger than the diameter of the substrate hole. The second washer is configured to be located about a portion of the central shaft. The tension control bolt assembly still further includes a nut, wherein the nut includes an internal threaded portion configured to engage a portion of the threaded portion of the central shaft.

According to another aspect, the subject application involves a tension control bolt assembly for securing two or more substrates together through a substrate hole. Only one side of the substrate hole is functionally accessible by an operator. The tension control bolt assembly includes a bolt. The bolt includes a distal portion and a proximal head located at the distal portion. The proximal head includes an outside diameter which is lesser than a diameter of the substrate hole. The bolt further includes a central shaft attached to the proximal head. The central shaft includes a central shaft diameter and a threaded portion. The bolt further includes a proximal portion attached to the central shaft. The proximal portion includes one or more engagement surfaces configured to be engaged by an associated application tool. The proximal portion is mechanically separable from the central shaft. The tension control bolt assembly also includes a first washer having a major diameter and a minor diameter. The major diameter is larger than the diameter of the substrate hole, and the first washer is configured to be passed through the substrate hole. The minor diameter is greater than the central shaft diameter and is configured to be located about a portion of the central shaft. The tension control bolt assembly further includes a second washer having an exterior diameter larger than the diameter of the substrate hole. The second washer is configured to be located about a portion of the central shaft. The tension control bolt assembly still further includes a nut, wherein the nut includes an internal threaded portion configured to engage a portion of the threaded portion of the central shaft. At the completion of tightening the nut onto the central shaft to develop a desired tensile force within the bolt, one or two complete revolutions of threads are exposed between the proximal portion and the threaded portion.

According to another aspect, the subject application involves a tension control bolt assembly for securing two or more substrates together through a substrate hole. Only one side of the substrate hole is functionally accessible by an operator. The tension control bolt assembly includes a bolt. The bolt includes a distal portion and a proximal head located at the distal portion. The proximal head includes an outside diameter which is lesser than a diameter of the substrate hole. The bolt further includes a central shaft attached to the proximal head. The central shaft includes a central shaft diameter and a threaded portion. The bolt further includes a proximal portion attached to the central shaft. The proximal portion includes one or more engagement surfaces configured to be engaged by an associated application tool. The proximal portion is mechanically separable from the central shaft. The tension control bolt assembly also includes a first washer having a major diameter and a minor diameter. The major diameter is larger than the diameter of the substrate hole, and the first washer is configured to be passed through the substrate hole. The minor diameter is greater than the central shaft diameter and is configured to be located about a portion of the central shaft. The tension control bolt assembly further includes a second washer having an exterior diameter larger than the diameter of the substrate hole. The second washer is configured to be located about a portion of the central shaft. The tension control bolt assembly still further includes a nut, wherein the nut includes an internal threaded portion configured to engage a portion of the threaded portion of the central shaft. At least one of the proximal head and the first washer define a serrated surface, the serrated surface is configured to limit rotational motion of the bolt during a fastening operation.

According to another aspect, the subject application involves a tension control bolt assembly for securing two or more substrates together through a substrate hole. Only one side of the substrate hole is functionally accessible by an operator. The tension control bolt assembly includes a bolt. The bolt includes a distal portion and a proximal head located at the distal portion. The proximal head includes an outside diameter which is lesser than a diameter of the substrate hole. The bolt further includes a central shaft attached to the proximal head. The central shaft includes a central shaft diameter and a threaded portion. The bolt further includes a proximal portion attached to the central shaft. The proximal portion includes one or more engagement surfaces configured to be engaged by an associated application tool. The proximal portion is mechanically separable from the central shaft. The tension control bolt assembly also includes a first washer having a major diameter and a minor diameter. The major diameter is larger than the diameter of the substrate hole. The minor diameter is greater than the central shaft diameter and is configured to be located about a portion of the central shaft. The tension control bolt assembly further includes a second washer having an exterior diameter larger than the diameter of the substrate hole. The second washer is configured to be located about a portion of the central shaft. The tension control bolt assembly still further includes a nut, wherein the nut includes an internal threaded portion configured to engage a portion of the threaded portion of the central shaft. The proximal head and the first washer each define an opposing, cooperating, serrated surface, the serrated surfaces are configured to limit rotational motion of the bolt during a fastening operation.

According to another aspect, the subject application involves a tension control bolt assembly for securing two or more substrates together through a substrate hole. Only one side of the substrate hole is functionally accessible by an operator. The tension control bolt assembly includes a bolt. The bolt includes a distal portion and a proximal head located at the distal portion. The proximal head includes an outside diameter which is lesser than a diameter of the substrate hole. The bolt further includes a central shaft attached to the proximal head. The central shaft includes a central shaft diameter and a threaded portion. The bolt further includes a proximal portion attached to the central shaft. The proximal portion includes one or more engagement surfaces configured to be engaged by an associated application tool. The proximal portion is mechanically separable from the central shaft. The tension control bolt assembly also includes a sleeve located on the central shaft and comprising a cylindrical portion of which the inner diameter is larger than the outer diameter of the central shaft, the outer diameter is less than the diameter of the substrate hole, and the length is less than the distance between the first washer and the second washer when installed in the substrate hole.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is a cross-section view of a tension control bolt assembly fastened around two substrates in accordance with aspects of the present disclosure;

FIG. 2 is a perspective view of a bolt used in the tension control bolt assembly of FIG. 1;

FIG. 3A is a detail end view of a proximal portion of the bolt of FIG. 2 showing a square engagement surface;

FIG. 3B is a detail side view of the proximal portion of FIG. 3A;

FIG. 3C is similar to FIG. 3B showing a reduced diameter portion between the proximal portion and a central shaft;

FIG. 4A is a detail end view of a proximal portion of the bolt of FIG. 2 showing an octagonal cross-section engagement surface;

FIG. 4B is a detail side view of the proximal portion of FIG. 4A;

FIG. 4C is similar to FIG. 4B showing a reduced diameter portion between the proximal portion and the central shaft;

FIG. 5A is a detail view of a first washer as used in the tension control bolt assembly of FIG. 1;

FIG. 5B is similar to FIG. 5A showing the first washer having a radially serrated top surface;

FIG. 5C is similar to FIG. 5B showing the first washer having two radially serrated surfaces;

FIG. 5D is similar to FIG. 5A showing the first washer having a serrated top surface in a cross hatch pattern;

FIG. 5E is similar to FIG. 5D showing the first washer having a two serrated surfaces in a cross hatch pattern;

FIG. 5F is similar to FIG. 5A showing the first washer having a knurled top surface;

FIG. 5G is similar to FIG. 5F showing the first washer having two knurled surfaces;

FIG. 6A is similar to FIG. 5A, showing the first washer having a flexible membrane connecting separate parts of the first washer while in a folded position;

FIG. 6B is similar to FIG. 6A, showing the first washer having a radially serrated top surface;

FIG. 6C is similar to FIG. 6B showing the first washer having two radially serrated surfaces;

FIG. 6D is similar to FIG. 6A showing the first washer having a serrated top surface in a cross hatch pattern;

FIG. 6E is similar to FIG. 6D showing the first washer having a two serrated surfaces in a cross hatch pattern;

FIG. 6F is similar to FIG. 6A showing the first washer having a knurled top surface;

FIG. 6G is similar to FIG. 6F showing the first washer having two knurled surfaces;

FIG. 7 is a perspective view showing an associated application tool placing the tension control bolt of FIG. 1 into a substrate hole;

FIG. 8 is similar to FIG. 1 showing the proximal portion removed from the bolt;

FIG. 9A is a detail view of a proximal head including a radially serrated surface adjacent to a central shaft;

FIG. 9B is a detail view of the proximal head and a first washer having a radially serrated bottom surface;

FIG. 9C is a detail view of the proximal head and the first washer having a radially serrated top surface; and

FIG. 9D is a detail view of the proximal head and the first washer having cooperating serrated surfaces;

FIG. 10A is a detail view of the a second washer as used in the tension control bolt assembly of FIG. 1;

FIG. 10B is similar to FIG. 10A showing the second washer having a radially serrated top surface;

FIG. 10C is similar to FIG. 10A showing the second washer having a serrated top surface in a cross hatch pattern; and

FIG. 10D is similar to FIG. 10A showing the second washer having a knurled top surface.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements.

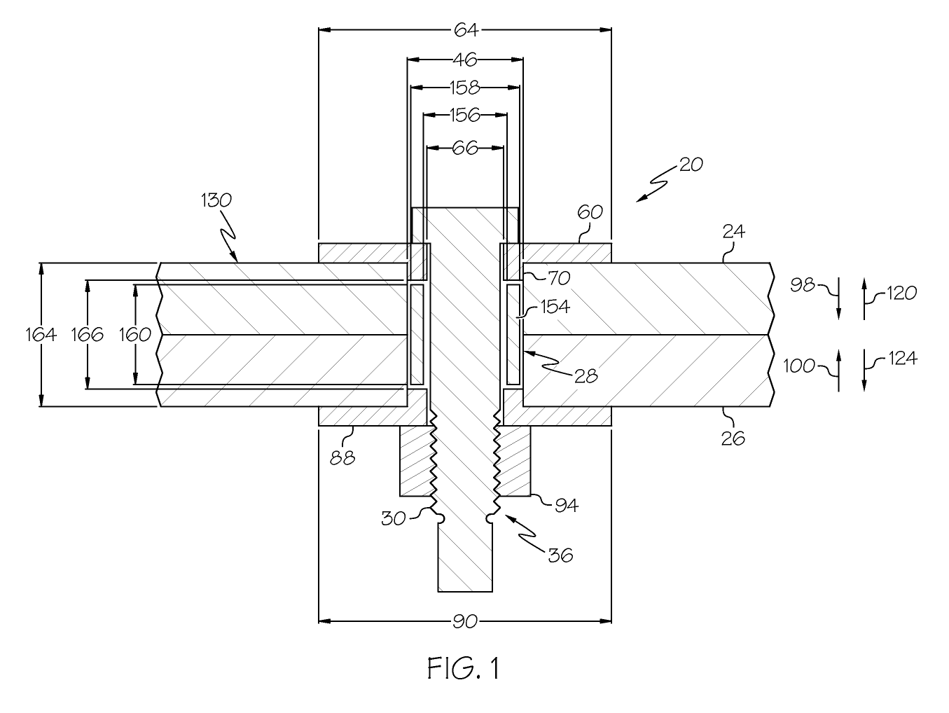

FIG. 1 shows a perspective view of a tension control bolt assembly 20 according to at least one aspect of the present disclosure. The tension control bolt assembly 20 is used for securing two or more substrates 24, 26 together through a substrate hole 28 in instances when only one side of the substrate hole 28 is functionally accessible by an operator. When the substrate hole 28 is accessible only from one side, it may be referred to as a “blind hole.”

The tension control bolt assembly 20 can be used during complex construction fastening systems including, but not limited to, joining structural members, joining simple and complex structures including, but not limited to, castings, forgings, and weldments when there is no access to a rear side of a joint. The tension control bolt assembly 20 can be used in the construction of structures such as bridges, buildings, wind turbines, power transmission structures, and a multitude of other applications where high strength, durability, and the capability of providing relatively high compressive force applied to the substrates are important factors. As such, substrates 24, 26 can represent two pieces of structural steel secured or bolted together to form a portion of a structural frame. Additionally, the use of the tension control bolt assembly 20 of this disclosure provides for a reliable and observable demonstration of the required compressive force applied to the substrates generated by application of the tension control bolt assembly 20 to the joint it secures.

Turning to FIG. 2, the tension control bolt assembly 20 includes a bolt 30. The bolt 30 includes a distal portion 34, a central shaft 36, and a proximal portion 38. The distal portion 34 includes a proximal head 40 having an outside diameter 44 which is lesser than a diameter 46 of the substrate hole 28 (best seen in FIG. 1). This relationship between the outside diameter 44 of the proximal head 40 and the diameter 46 of the substrate hole 28 enables the proximal head 40 to be passed through the substrate hole 28. The proximal head 40 can take any suitable form including, but not limited to the standard forms of a button head, a hex head, cap head, internal and/or external spline head, etc.

The central shaft 36 is attached to the proximal head 40 and includes a central shaft diameter 48 and a threaded portion 50. The threaded portion 50 is configured to interact with a nut which will be described below. The threads can include any suitable thread characteristics such as pitch and lead including, but not limited to, standard thread forms typically used in high-strength tension bolt construction applications.

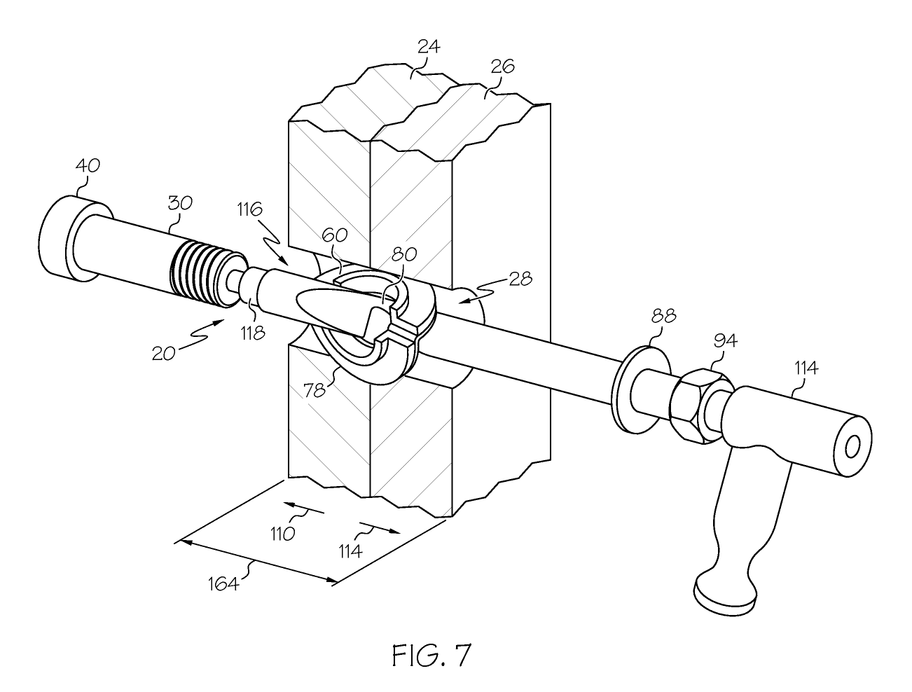

The proximal portion 38 of the bolt 30 is attached to the central shaft 36 and includes one or more engagement surfaces 54 configured to be engaged by an associated application tool which will be described below and is best seen in FIG. 7. In one example, the engagement surface 54 can include a portion extending longitudinally from the central shaft 36. The engagement surface 54 can include a particular cross-section profile including, but not limited to a square cross section profile 56, an eight-pointed cross-section profile 57, and other suitable profiles. These cross-sectional profiles 56, 57 can interact with various cooperating female cross-section profiles of an associated tensioning tool element in order to prevent rotation of the bolt 30.

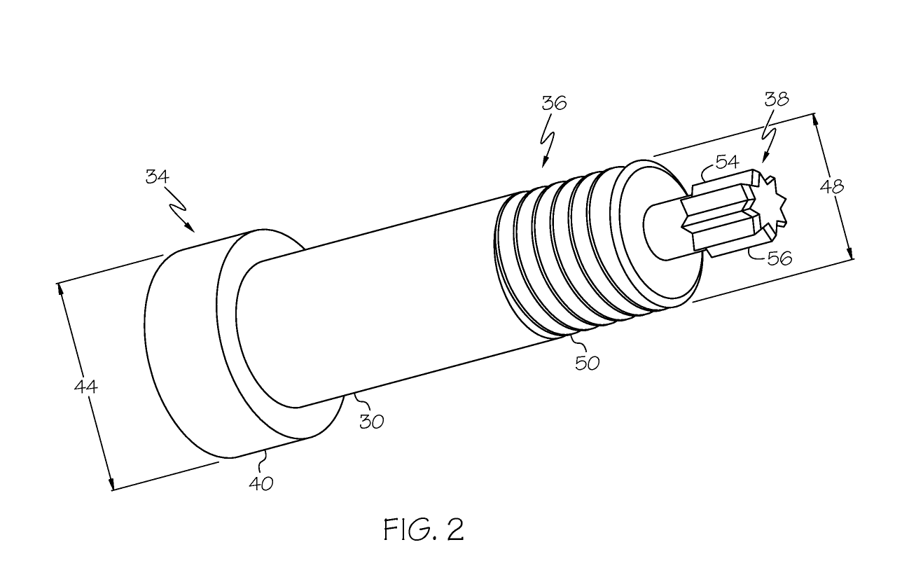

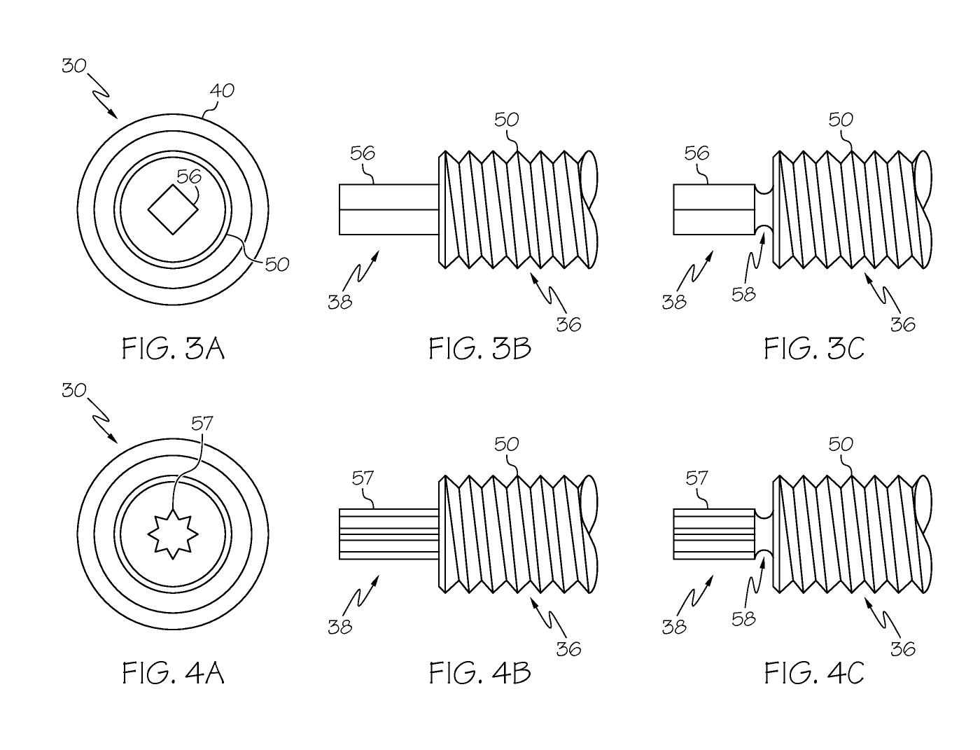

In one example, as shown in FIGS. 3A and 3B, the cross-sectional profile 56 can include a square cross-section. In another example, as shown in FIGS. 4A and 4B, the cross-sectional profile 57 can include an eight-pointed cross-section. It is to be appreciated that the cross-sectional profiles 56, 57 are merely examples of cross-sectional profile shapes and any suitable cross-sectional profile shape, such as octagonal, hexagonal, or any other shape can be used. Furthermore, it is to be appreciated that the described cross-sectional profiles 56, 57 (having square and eight-pointed cross-sections) can both be held in place by a single cooperating female splined profile on the associated tensioning tool having eight points. In this way, a single selected tensioning tool element can be used in conjunction with tension control bolt assemblies having either described selected cooperating cross-sectional profile and perhaps other cooperating cross-sectional profiles.

As shown in FIGS. 3C and 4C, a segment of the bolt 30 can define a reduced diameter portion 58 or reduced diameter between the proximal portion 38 and the central shaft 36. In one example, the reduced diameter portion 58 can be annular in shape and configured to correspond to a cooperating structure attached to or otherwise comprising the associated application tool. This interaction between the reduced diameter portion 58 and the associated application tool will be described below.

The bolt 30 can be formed using any suitable manufacturing method and the bolt can be constructed of any material suitable for high-strength applications such as steel, Inconel, stainless steel, or similar materials.

Returning to FIG. 1, the tension bolt assembly 20 also includes a first washer 60 having a major diameter 64 and a minor diameter 66. The major diameter 64 is larger than the diameter 46 of the substrate hole 28 such that the first washer 60 cannot pass through the substrate hole 28 after the first washer 60 has been placed on the rear side of the joint adjacent to the proximal head. Additionally, the minor diameter 66 of the first washer 60 is greater than the diameter 48 (best seen in FIG. 2) of the central shaft 36 enabling the first washer 60 to be located about a portion of the central shaft 36 as the central shaft 36 passes through the minor diameter 66 of the first washer 60.

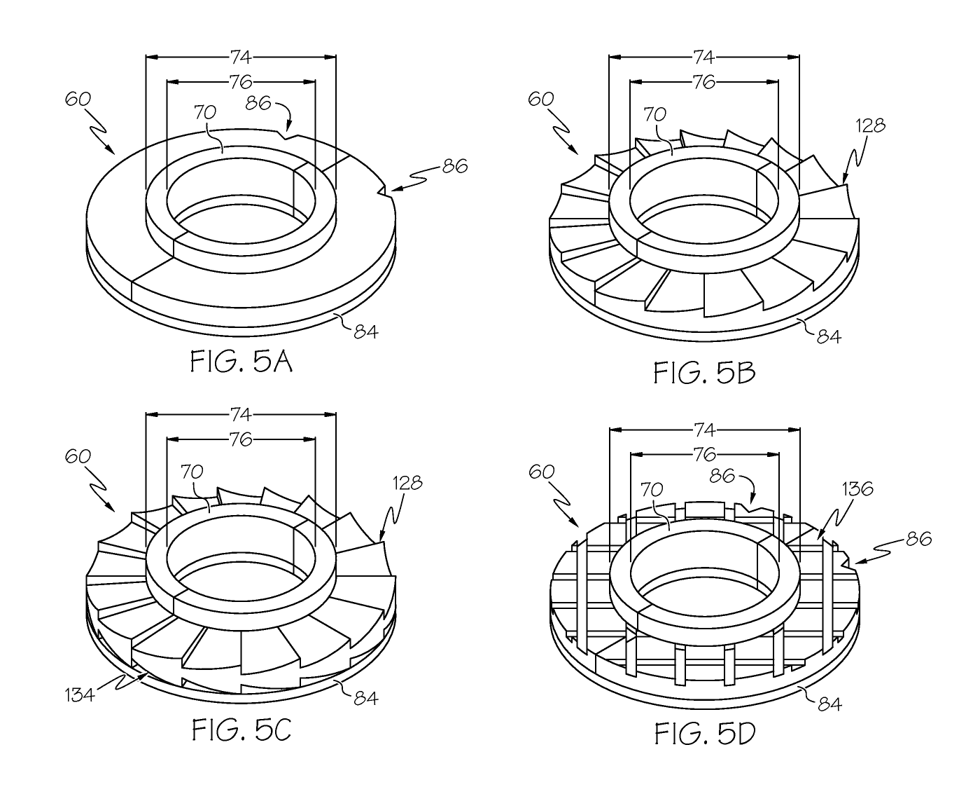

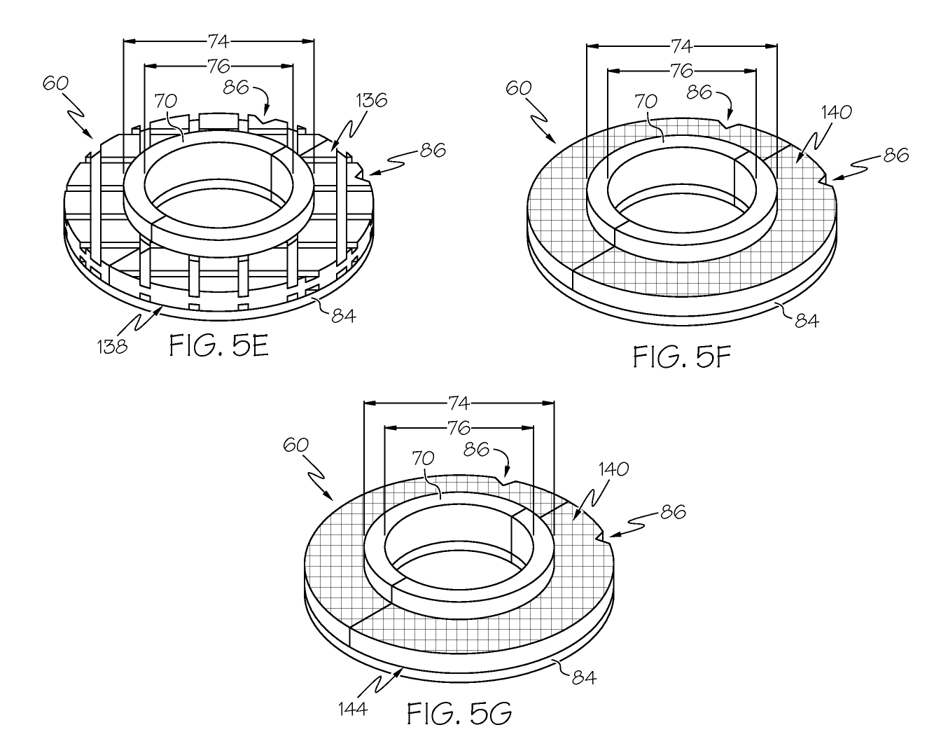

Turning to FIG. 5A, the first washer 60 can include a ridge 70 proximal to the minor diameter 66 and the ridge 70 can include a ridge major diameter 74 and a ridge minor diameter 76. In one example, the ridge major diameter 74 is slightly smaller than the diameter 46 of the substrate hole 28. In another example, the ridge minor diameter 76 is slightly larger than the diameter 48 of the central shaft 36. The diameter 48 can be slightly smaller than the ridge minor diameter 76 enabling the central shaft 36 to pass through the minor diameter 76. Furthermore, the ridge major diameter 74 can be substantially equal to the outside diameter 44 of the proximal head 40. As shown in FIG. 1, the ridge 70 can at least partially penetrate the substrate hole 28 which can operate to locate the several components of the tension bolt assembly 20 concentrically with the axis of the substrate hole 28 such as to assist in the operation of applying the compressive force to the substrate 24, 26.

Because the tension bolt assembly 20 is applied to blind holes and an operator cannot gain access to the rear side of the components to be fastened together, there is a need to position the first washer 60 between the substrate 24 and the proximal head 40 while not using an operator's hand or fingers to do so. When the first washer 60 is located in this position, the proximal head 40 is prevented (by physical interference) from passing through the substrate hole 28 as the tension control bolt assembly 20 joins the substrates 24, 26.

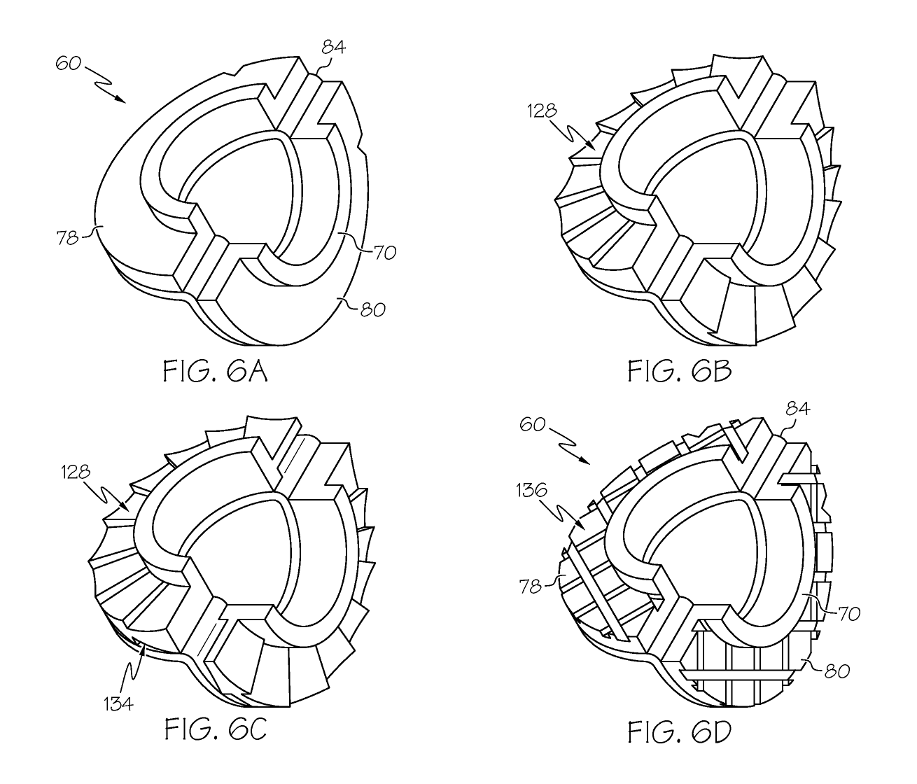

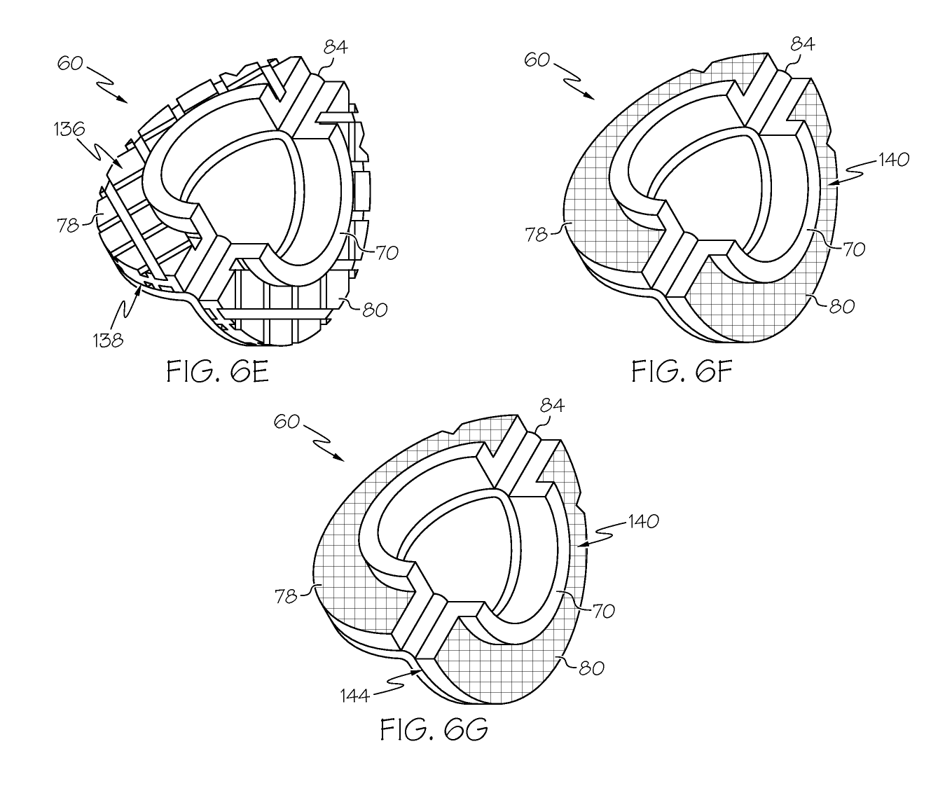

To accomplish the objective of locating the first washer 60 as described, the first washer 60 can be configured to be passed through the substrate hole 28. In the shown example of FIG. 6A, the first washer 60 is divided into two sections 78, 80 at a diameter of the first washer 60. One side of the first washer 60 can include an attachment material 84 which flexibly connects the divided two sections 78, 80 of the first washer 60. The attachment material 84 can include, but is not limited to polymers, paper, and flexible metal, each adhesively attached to the thereby connected divided sections 78, 80. Any suitable method and structure accomplishing the flexible attachment of the two sections 78, 80 is contemplated. In another example, the two sections 78, 80 can be joined by a flexible material (e.g., a polymer) that is embedded into both sections 78, 80 at the parallel surfaces marking the dividing line between the sections 78, 80. With this flexible connection, the divided two sections 78, 80 can be folded such that the first washer 60 and so configured will pass through the substrate hole 28. However, when the two sections 78, 80 are fully extended, the resultant diameter of the first washer 60 is greater than the diameter 46 of the substrate hole 28.

Returning to FIG. 5A, the first washer 60 defines structure 86 which interacts with the associated application tool to enable the bolt 30 and the first washer 60 to be inserted into and through the substrate hole 28 when the axis thereof is oriented at any angle. It is to be appreciated that the first washer 60 sections 78, 80 tend to resume the fully extended position when passing the first washer 60 through a vertical substrate hole 28. In order to prevent this, structure such as fingers, springs, latches, etc. attached to and/or comprising the associated application tool maintain the first washer 60 and its two sections 78, 80 in a folded position until the first washer 60 is passed through the vertical substrate hole 28. After the first washer 60 is passed through the vertical substrate hole 28, the structure attached to the associated application tool can be moved from the structure 86, enabling the two sections 78, 80 to resume or expand into the fully extended position so that the tension bolt assembly 20 can be tensioned by the rotation of a nut 94 to join the substrates 24, 26 with the first washer 60 in its operative position. In one example, the force of gravity urges the first washer 60 to the fully extended position against the substrate 24.

Returning to FIG. 1, the tension bolt assembly 20 also includes a second washer 88. The second washer 88 has an exterior diameter 90 larger than the diameter of the substrate hole 28, preventing passage of the second washer 88 and any other components mounted outboard of the second washer from passing into and/or through the substrate hole 28. Additionally, an increased exterior diameter 90 increases the contact area of the second washer 88 thereby distributing the compressive force generated by the rotation of the nut 94 to improve the joining of the substrates 24, 26. The second washer 88 is configured to be located about a portion of the central shaft 36.

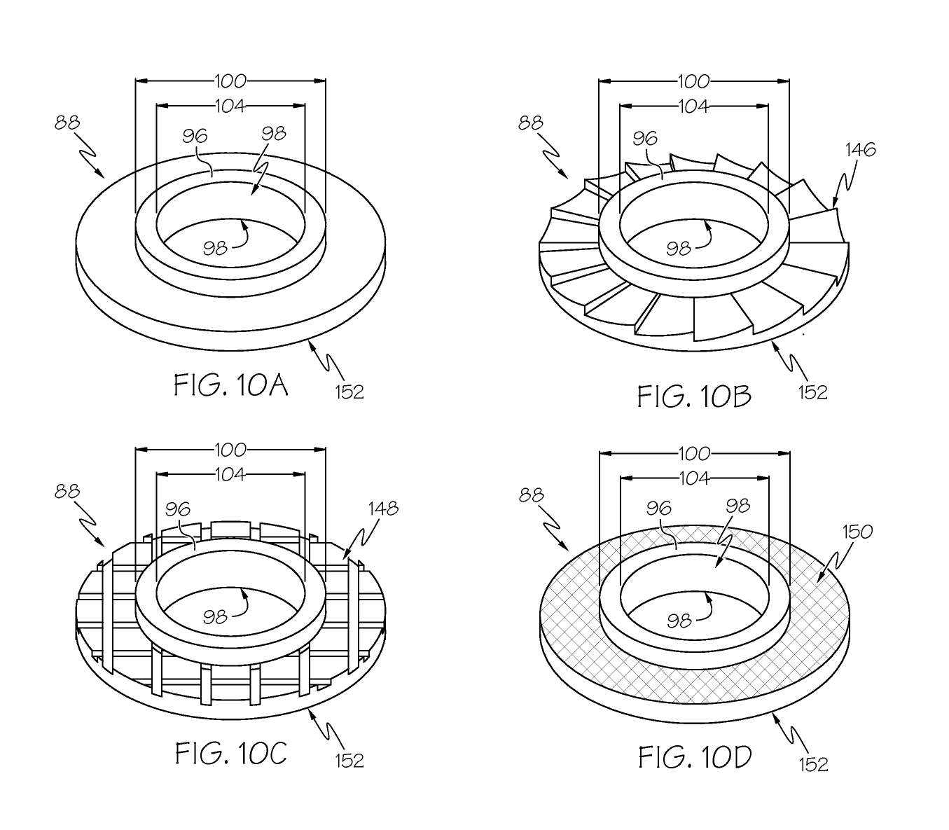

Turning to FIG. 10A, the second washer 88 can include a ridge 96 proximal to a central passage 98 and the ridge 96 can include a ridge major diameter 100 and a ridge minor diameter 104. In one example, the ridge major diameter 100 is slightly smaller than the diameter 46 of the substrate hole 28. In another example, the ridge minor diameter 104 is slightly larger than the diameter 48 of the central shaft 36. The diameter 48 can be slightly smaller than the ridge minor diameter 104 enabling the central shaft 36 to pass through the minor diameter 104 with relative ease. Furthermore, the ridge major diameter 100 can be substantially equal to the outside diameter 44 of the proximal head 40. As shown in FIG. 1, the ridge 96 can at least partially penetrate the substrate hole 28 which can operate to locate the several components of the tension bolt assembly 20 concentrically with the axis of the substrate hole 28 such as to assist in the operation of applying the compressive force to the substrate 24, 26.

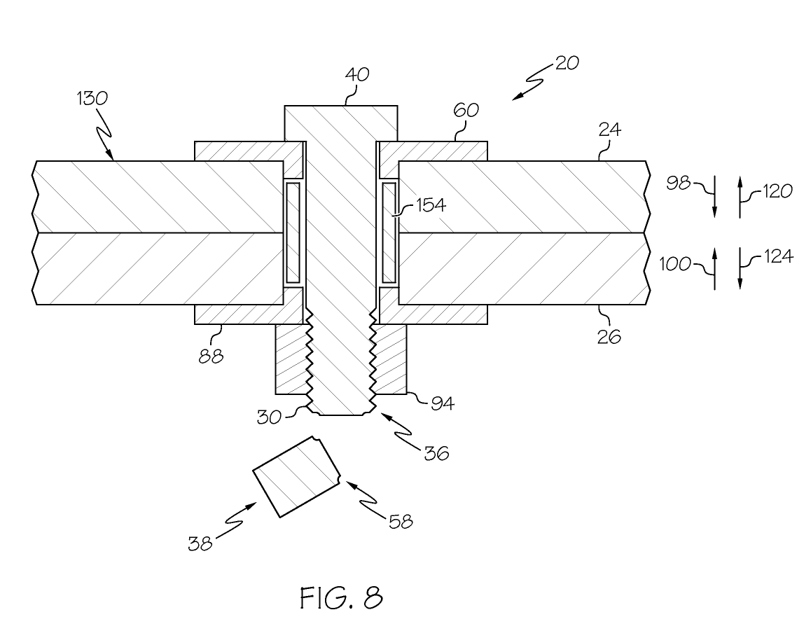

The tension bolt assembly 20 further includes the previously mentioned nut 94 having an internal (or female) threaded portion 106 (best seen in FIG. 8) configured to engage the external threaded portion 50 of the central shaft 36. It is to be understood that as the nut 94 is rotated onto the threads of the external threaded portion 50, a compressive force is generated in the direction of arrows 98, 100 which compresses the substrates 24, 26 together to form a secure bond in conjunction with the tension bolt assembly 20.

As shown in FIG. 7, the associated application tool 114 can be used to place the components of the tension bolt assembly 20 in the proper order and location to fasten the substrates 24, 26. The nut 94 can be passed over the distal end 116 of the associated application tool first, followed by the second washer 88. Then, the first washer 60 can be passed over the distal end 116 and then folded about a narrowed section of the associated application tool 114. As previously described, structure such as a finger, spring, latch, etc. can be attached to the associated application tool 114 to maintain the first washer 60 and its two sections 78, 80 in a folded position until the first washer 60 is passed through the substrate hole 28. At this reduced cross-section size, the first washer 60 can be passed through the substrate hole 28 to be placed between the substrate 24 and the proximal head 40.

At this time, the bolt 30 can be attached to the associated application tool 114. As mentioned above, a selected female cross-section profile 118 at the distal end 116 of the associated application tool 114 can at least partially surround the selected profile of the proximal portion 38. The insertion length, and tolerances of the selected female cross-section profile 118 and the proximal portion 38 can be designed and/or arranged to promote reliable and repeatable engagement between the bolt 30 and the associated application tool 114 such that the joined pair can be oriented in any direction for proper tension bolt assembly 20 application. In other words, the selected female cross-section profile 118 can reliably hold the bolt 30 at any required angle during the installation procedure without the bolt 30 separating from the associated application tool 114.

In another example, the associated application tool 114 and/or the selected female cross-section profile 118 can include structure to correspond with the reduced diameter portion 58 between the proximal portion 38 and the central shaft 36. This interaction between the reduced diameter portion 58 and the associated application tool 114 can help hold the bolt 30 on the associated application tool 114.

Then, the associated application tool 114 is placed into the substrate hole 28 and places the entire bolt 30 on the far (blind) side of the substrate hole 28. The first washer 60 is then released by the structure (e.g., a finger, spring, etc.) attached to the associated application tool 114 enabling the first washer 60 and its two sections 78, 80 to extend into the fully operational orientation and cooperate with the substrate 24 as seen in FIG. 1. The operator can then partially retract the associated application tool from the substrate hole 28 such that threads of the threaded portion 50 are exposed on the visible side of the substrate 26. The operator can then (by hand) axially move the second washer 88 and the nut 94 and begin threading the nut 94 onto the threaded portion 50. The operator can then remove the associated application tool 114 completely from the tension bolt assembly 20 to disengage the associated application tool 114 from the bolt 30.

The operator can then apply a rotational movement to the nut 94 to thereby develop a compressive force between the substrates 24, 26. This compressive force generates an equal and opposite tensile force in the direction of arrows 120, 124 within the bolt 30. As was noted previously, the materials of the tension bolt assembly 20 and the configuration can be calculated and selected to enable the tension bolt assembly 20 to withstand the high tension forces that are often required by construction or any other industry standards, which can be in the range of thousands to tens of thousands of pounds per square inch.

It is also to be appreciated that by placing a particular rotational movement to the nut 94, such movement will develop a particular resultant tensile force within the bolt 30. As such, a designer can, knowing the required compressive force to joint two substrates 24, 26, calculate the required torque force to apply to the nut 94 to develop the resultant tensile force within the bolt 30 which creates an equal and opposite compressive force on the substrates 24, 26. Thus, an operator in the field can be informed of the desired rotational torque and apply that desired force during the rotation of the nut 94 to develop the desired joint characteristics to meet construction or any other industry standards. In one example, the nut 94 can be applied to the threaded portion 50 with the use of a fastening tool (not shown) such as a torque wrench. The torque wrench can be powered with any suitable means including manual force, air pressure, battery power, utility electricity, etc.

It is to be appreciated that the various components of the tension bolt assembly 20 can be designed and constructed such that one or two complete revolutions of threads are exposed between the proximal portion 36 and the threaded portion 50 when the nut 94 has been applied to the threaded portion 50 of the bolt 30 and rotated such as to develop a particular desired resultant tensile force within the bolt 30 and compressive force between the substrates 24, 26.

In one particular example, the fastening tool can interact with the tension bolt assembly 20 at two locations. For example, the fastening tool can include a female portion having an internal perimeter that corresponds with the exterior of the nut 94. The fastening tool can further include a selected female cross-section profile having a perimeter that corresponds with the exterior of the selected profile 56, 57. In this particular example, the fastening tool can apply the desired torque as described above to the nut 94 while restraining the rotation of the selected profile 56, 57 and therefore, the bolt 30 to apply the nut 94 to the bolt 30. In another example, it is possible to rotate one of the nut 94 and the selected profile 56, 57 in one direction while rotating the other of the nut 94 and the selected profile 56, 57 in the opposite direction to reduce the time needed to develop the required rotation of the nut and the development of the required compressive force on the substrates 24, 26.

Turning to FIG. 8, the proximal portion 38 can be mechanically separable from the central shaft 36, and the proximal portion 38 is removed from the central shaft 36 during the fastening operation. For example, the design and manufacture of the proximal portion 38 can enable the proximal portion 38 to consistently and reliably separate at a particular torque value. This torque value can correspond to a predetermined desired tensile force within the bolt 30. Thus, as the nut 94 is applied to the bolt 30 and rotated to obtain the required compressive force, the proximal portion 38 reaches its maximal torsional stress and separates from the bolt 30. This separation of the proximal portion 38 can serve multiple purposes. First, the tension bolt assembly 20 includes a fail-safe method of application to a joint. For example, the operator does not have to determine as to any over-tightening or under-tightening the nut 94; the proximal portion 38 consistently and reliably separates at the required torque value. Second, the operator, a supervisor, and/or an inspector can readily see which tension bolt assemblies 20 and joints have been properly fastened merely by observing which tension bolt assemblies 20 lack proximal portions 38.

In another example, the reduced diameter portion 58 can be designed and manufactured to separate at a selected torque value, which may provide a more re-producible, controlled separation location for the proximal portion 38. In this instance, as the nut 94 reaches its desired torque value, the reduced diameter portion 58 reaches its maximum torsional stress allowed by the material and geometry at the reduced diameter portion 58 and then separates the proximal portion 38 from the bolt 30.

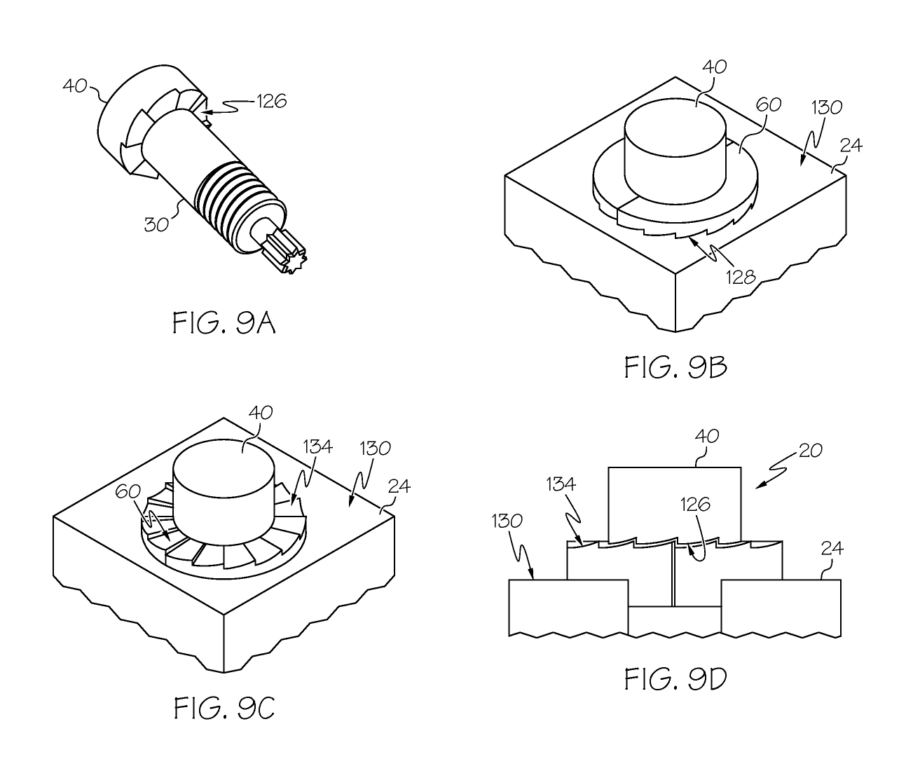

Turning to FIG. 9A, radially serrated edges are shown on the proximal head 40. The proximal head 40 can be configured to define a radially serrated surface 126. The radially serrated surface 126 is configured to limit and/or prevent rotational motion of the bolt 30 during the fastening operation of the tension bolt assembly 20. Limiting and/or preventing rotation of the bolt 30 enables the nut 94 (best seen in FIG. 1) to be adequately secured to the bolt 30 to develop the desired tensile force within the bolt 30 and the compressive force between the substrates 24, 26.

In another example as shown in FIG. 9B, the first washer 60 defines a radially serrated surface 128 which contacts an exterior surface 130 of one of the substrates 24, 26. The ridges of the radially serrated surface 128 produce suitable mechanical interference and/or frictional force to limit and/or prevent rotation of the first washer 60 during the fastening operation. Alternatively, the first washer 60 can define a radially serrated surface 134 which contacts the proximal head 40 as shown in FIG. 9C. The radially serrated surface 134 is configured to limit and/or prevent rotational motion of the first washer 60 and/or the bolt 30 during the fastening operation of the tension bolt assembly 20.

In another example shown in FIG. 9D, the proximal head 40 also defines a radially serrated surface 126 as previously described which contacts the radially serrated surface 134. Similar to the arrangement described above, the radially serrated surface 126 located on the proximal head 40 and the serrated surface 134 of the first washer 60 are configured to limit and/or prevent rotational motion of the bolt 30 during the fastening operation of the tension bolt assembly 20. For example, the proximal head 40 and the first washer 60 each define an opposing cooperating serrated surface 126, 134 which are configured to limit rotational motion of the bolt 30 during a fastening operation. As can be seen in FIG. 9D, the directionally radial serrations of the opposing cooperating serrated surfaces 126, 134 can be arranged in such a manner that the acutely angled surfaces (or substantially vertical surfaces) can act against each other in one particular direction of rotation while the obtuse angled surfaces can more easily slide past each other in the opposing direction of rotation. With this arrangement, the proximal head 40 can more easily turn in one direction (e.g., the counter-clockwise direction) while being limited or prevented from rotation in the opposite direction (e.g., clockwise).

Turning to FIG. 5B, the first washer 60 is shown with the radially serrated surface 128 which contacts the surface 130 of one of the substrates 24, 26. FIG. 5C shows the radially serrated surface 128 and the radially serrated surface 134 which faces the proximal head 40. Of course, the first washer 60 can also define other surface types to lessen and/or prevent rotation of the bolt 30 during a fastening operation. For example, FIG. 5D shows a cross-hatch serrated surface 136 which contacts the surface 130 of one of the substrates 24, 26. FIG. 5E shows the cross-hatch serrated surface 136 and a cross-hatch serrated surface 138 which faces the proximal head 40. Similarly, FIG. 5F shows a knurled surface 140 which contacts the surface 130 of one of the substrates 24, 26. FIG. 5G shows the knurled surface 140 and a knurled surface 144 which faces the surface 130 of one of the substrates 24, 26. It is to be understood that suitable serration, shaped-surface, or combination of the described surfaces can be included on the first washer 60 to prevent rotation of the bolt 30 during the tensioning operation.

Similarly, FIGS. 6B-6G show the first washer 60 in a partially folded position and the surfaces 128, 134, 136, 138, 140, 144 corresponding to those shown in FIGS. 5B-5G.

As shown in FIGS. 10B-10D, the second washer 88 can include a serrated surface 146, similar to the first washer 60. The serrated surface 146 is configured to limit and/or prevent rotational motion of the second washer 88 during the fastening operation of the tension bolt assembly 20. In some examples, the second washer 88 can include a radial serration as shown in FIG. 10B, a cross-hatch serrated surface 148 as shown in FIG. 10C, or a knurled surface 150 as shown in FIG. 10D. Each of the surfaces 146, 148, 150 contacts the surface 130 of one of the substrates 24, 26 to limit and/or prevent rotation of the second washer 88. Unlike the first washer 60, it can be beneficial to maintain a smooth surface 152 opposite the serrated surface, as it contacts the nut 94 and it can be beneficial to limit the impediments to rotating the nut 94 during the bolt tensioning operation.

Returning to FIG. 1, the tension bolt assembly 20 can also include a sleeve 154 located about the central shaft 36. The sleeve 154 is configured to have an inner diameter 156 greater than the central shaft diameter 48. The sleeve 154 includes an outer diameter 158 that is lesser than the diameter 46 of the substrate hole 28. The sleeve 154 also includes a length 160 that is lesser than the distance 164 between the outer faces of the substrates 24, 26 or, alternatively, lesser than the distance 166 between the inner faces of the ridges 70, 96 (best seen in FIGS. 6A-6G and 10A-10D) of the first washer 60 and the second washer 88, respectively. As such, the sleeve 154 is not compressed during the bolt tensioning operation and thereby operates to concentrically locate the several components of the tension bolt assembly 20 with respect to the axis of the substrate hole 28.

The described apparatus can provide advantages over other bolts used in construction elements with blind holes. For example, the tension bolt assembly as described can be used with an associated application tool to position the tension bolt assembly through the blind hole and position the folding first washer between the proximal head and one of the substrates with any blind hole orientation, regardless of the angular orientation of the axis of the substrate hole. Other, known blind hole bolts require the use of gravity to retain a washer in a particular orientation as it is placed through the blind hole. In these previously known apparatus, the blind bolt cannot be used in blind holes oriented other than near a substrate hole having a horizontal or near horizontal axis because gravity would tend to move the folding washer from a position enabling passage through the substrate hole.

While this disclosure has been written in conjunction with the specific embodiments described above, it is evident that many alternatives, combinations, modifications and variations are apparent to those skilled in the art. Accordingly, the described embodiments of this disclosure, as set forth above are intended to be illustrative only, and not in a limiting sense. Various changes can be made without departing from the spirit and scope of this disclosure. Combinations of the above embodiments and other embodiments will be apparent to those of skill in the art upon studying the above description and are intended to be embraced therein. Therefore, the scope of the present disclosure is defined by the appended claims, and all devices, processes, and methods that come within the meaning of the claims, either literally or by equivalence, are intended to be embraced therein. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tension control bolt assembly for securing two or more substrates together through a substrate hole wherein only one side of said substrate hole is functionally accessible by an operator comprising:
a bolt comprising:
a distal portion;
a proximal head located at said distal portion, wherein said proximal head includes an outside diameter which is lesser than a diameter of said substrate hole;
a central shaft attached to said proximal head, wherein said central shaft includes a central shaft diameter and a threaded portion;
a proximal portion attached to said central shaft, said proximal portion includes one or more engagement surfaces configured to be engaged by an associated application tool, and said proximal portion is mechanically separable from said central shaft;
a first washer having a major diameter and a minor diameter, said major diameter is larger than the diameter of said substrate hole, said first washer is configured to be passed through said substrate hole, said minor diameter is greater than said central shaft diameter and is configured to be located about a portion of said central shaft, said first washer defines structure which interacts with the associated tool to enable said bolt and said first washer to be inserted into said substrate hole having an axis which is oriented in any plane including the vertical;
a second washer having an exterior diameter larger than said diameter of said substrate hole, said second washer is configured to be located about a portion of said central shaft; and
a nut, wherein said nut includes an internal threaded portion configured to engage a portion of said threaded portion of said central shaft.

2. The tension control bolt assembly according to claim 1, wherein said first washer is divided into two sections.

3. The tension control bolt assembly according to claim 2, wherein said first washer further comprises an attachment material, wherein said attachment material flexibly connects said two sections of said first washer.

4. The tension control bolt assembly according to claim 1, wherein said first washer further comprises a ridge proximal to said minor diameter, said ridge including a ridge major diameter and a ridge minor diameter.

5. The tension control bolt assembly according to claim 4, wherein said ridge major diameter is slightly smaller than the diameter of said substrate hole.

6. The tension control bolt assembly according to claim 4, wherein said ridge minor diameter is slightly larger than said central shaft diameter.

7. The tension control bolt assembly according to claim 4, wherein said ridge major diameter is substantially equal to an outside diameter of said proximal head.

8. The tension control bolt assembly according to claim 1, further comprising a sleeve located about said central shaft, wherein said sleeve is not compressed during a bolt fastening operation.

9. A tension control bolt assembly for securing two or more substrates together through a substrate hole wherein only one side of said substrate hole is functionally accessible by an operator comprising:
a bolt comprising:
a distal portion;
a proximal head located at said distal portion, wherein said proximal head includes an outside diameter which is lesser than a diameter of said substrate hole;
a central shaft attached to said proximal head, wherein said central shaft includes a central shaft diameter and a threaded portion;
a proximal portion attached to said central shaft, said proximal portion includes one or more engagement surfaces configured to be engaged by an associated application tool, and said proximal portion is mechanically separable from said central shaft;
a first washer having a major diameter and a minor diameter, said major diameter is larger than the diameter of said substrate hole, said first washer is configured to be passed through said substrate hole, said first washer has a minor diameter greater than said central shaft diameter and is configured to be located about a portion of said central shaft;
a second washer having an exterior diameter larger than said diameter of said substrate hole, said second washer is configured to be located about a portion of said central shaft; and
a nut, wherein said nut includes an internal threaded portion configured to engage a portion of said threaded portion of said central shaft,
wherein at the completion of tightening said nut onto said central shaft to develop a desired tensile force within said bolt, one or two complete revolutions of threads are exposed between said proximal portion and said threaded portion.

10. The tension control bolt assembly according to claim 9, wherein said proximal portion is removed from said central shaft during a bolt fastening operation.

11. The tension control bolt assembly according to claim 10, wherein an associated fastening tool engages said proximal portion and removes said proximal portion from said central shaft as said nut reaches a predetermined torque value, said predetermined torque value developing a predetermined tension value within said bolt.

12. The tension control bolt assembly according to claim 9, wherein said bolt further comprises a reduced diameter portion between said proximal portion and said central shaft.

13. The tension control bolt assembly according to claim 9, wherein said proximal portion includes a spline profile on an exterior surface, said spline profile is configured to engage a corresponding spline on the associated application tool.

14. The tension control bolt assembly according to claim 9, further comprising a sleeve located about said central shaft, wherein said sleeve is not compressed during a bolt fastening operation.

15. A tension control bolt assembly for securing two or more substrates together through a substrate hole wherein only one side of said substrate hole is functionally accessible by an operator comprising:
a bolt comprising:
a distal portion;
a proximal head located at said distal portion, wherein said proximal head includes an outside diameter which is lesser than a diameter of said substrate hole;
a central shaft attached to said proximal head, wherein said central shaft includes a central shaft diameter and a threaded portion;
a proximal portion attached to said central shaft, said proximal portion includes one or more engagement surfaces configured to be engaged by an associated application tool;
a first washer having a major diameter and a minor diameter, said major diameter is larger than the diameter of said substrate hole, said first washer is configured to be passed through said hole, said first washer has a minor diameter greater than said central shaft diameter and is configured to be located about a portion of said central shaft;
a second washer having an exterior diameter larger than said diameter of said hole, said second washer is configured to be located about a portion of said central shaft; and
a nut, wherein said nut includes an internal threaded portion configured to engage a portion of said threaded portion of said central shaft,
wherein at least one of said proximal head and said first washer define a serrated surface, said serrated surface is configured to limit rotational motion of said bolt during a fastening operation.

16. The tension control bolt assembly according to claim 15, wherein said first washer defines said serrated surface on a portion of said first washer that contacts a surface of one of said two or more substrates.

17. The tension control bolt assembly according to claim 15, wherein said proximal head defines said serrated surface on a portion of said proximal head that contacts a surface of said first washer.

18. The tension control bolt assembly according to claim 15, wherein said proximal head defines said serrated surface on a portion of said proximal head that contacts a surface of said first washer and said first washer defines a cooperating serrated surface configured to engage said serrated surface on said portion of said proximal head.

19. The tension control bolt assembly according to claim 15, further comprising a sleeve located about said central shaft, wherein said sleeve is not compressed during a bolt fastening operation.

20. A tension control bolt assembly for securing two or more substrates together through a substrate hole wherein only one side of said substrate hole is functionally accessible by an operator comprising:
a bolt comprising:
a distal portion;
a proximal head located at said distal portion, wherein said proximal head includes an outside diameter which is lesser than a diameter of said substrate hole;
a central shaft attached to said proximal head, wherein said central shaft includes a central shaft diameter and a threaded portion;
a proximal portion attached to said central shaft, said proximal portion includes one or more engagement surfaces configured to be engaged by an associated application tool, and said proximal portion is mechanically separable from said central shaft;
a first washer having a major diameter and a minor diameter, said major diameter is larger than the diameter of said substrate hole, said minor diameter is greater than said central shaft diameter and is configured to be located about a portion of said central shaft;
a second washer having an exterior diameter larger than said diameter of said hole, said second washer is configured to be located about a portion of said central shaft; and
a nut, wherein said nut includes an internal threaded portion configured to engage a portion of said threaded portion of said central shaft,
wherein said proximal head and said first washer each define an opposing cooperating serrated surface, said serrated surfaces are configured to limit rotational motion of said bolt during a fastening operation.

21. A tension control bolt assembly for securing two or more substrates together through a substrate hole wherein only one side of said substrate hole is functionally accessible by an operator comprising:
a bolt comprising:
a distal portion;
a proximal head located at said distal portion, wherein said proximal head includes an outside diameter which is lesser than a diameter of said substrate hole;
a central shaft attached to said proximal head, wherein said central shaft includes a central shaft diameter and a threaded portion;
a proximal portion attached to said central shaft, said proximal portion includes one or more engagement surfaces configured to be engaged by an associated application tool, and said proximal portion is mechanically separable from said central shaft;
a first washer, said first washer is located about said central shaft;
a second washer, said washer is located about said central shaft; and
a sleeve, said sleeve is located about said central shaft between said first washer and said second washer, said sleeve comprises:
an inner diameter, said inner diameter is greater than said central shaft diameter;
an outer diameter, said outer diameter is less than a diameter of said substrate hole;
a length, said length is less than a distance between said first washer and said second washer when said tension control bolt assembly is installed in said substrate hole.
